(19) United States
(12) Patent Application Publication
(10) Pub. No.: US 2006/0007211 A1
(43) Pub. Date: Jan. 12, 2006

(54) Image display apparatus

(75) Inventors: Kazuhiko Murayama, Kanagawa (JP); Tadashi Aoki, Kanagawa (JP); Aoji Isono, Kanagawa (JP); Kenji Shino, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/128,345

(22) Filed: May 13, 2005

Related U.S. Application Data
(62) Division of application No. 10/211,521, filed on Aug. 5, 2002, now Pat. No. 6,970,162.

(30) Foreign Application Priority Data
Aug. 3, 2001 (JP) 2001-237027
Apr. 19, 2002 (JP) 2002-118296

(51) Int. Cl. G09G 5/00

(52) U.S. Cl. 345/204

(57) ABSTRACT

An image display apparatus having a plurality of image forming devices. In an output circuit provided between constant voltage supplies and wiring for driving each of the image forming devices, MOSFETs are successively turned on from the one having a higher ON resistance at the time of switching to make a stepwise transition between outputs from the constant voltage supplies, and have steady potential, thereby limiting undesirable variation in signal potential at the time of switching.

### DETAILED DESCRIPTION OF THE INVENTION

1. Technical Field of the Invention

The present invention relates to an image display method and an apparatus therefore of a television image signal or the like. More particularly, the invention relates to an image display method and an apparatus therefore having a driving circuit permitting industrialization of a matrix image display panel at a low cost.

2. Description of the Related Art

Two kinds of electron emission element including a hot cathode element and a cold cathode element have conventionally known. Within the category of cold cathode element, for example, there are known an electric field emitting element (hereinafter referred to as the “FE type”), a metal/insulating layer/metal type emitting element (hereinafter referred to as the “MIM type”), and a surface conduction type emitting element.

Known examples of the FE type element include W. P. Dyke & W. W. Dolan, “Field emission”, Advance in Electron Physics, 8, 89 (1956), C. A. Spindt, “Physical properties of thin-film field emission cathodes with molybdenum cones”, J. Appl. Physics, 47, 5248 (1976).

Among MIM-type elements, C. A. Mead, “Operation of tunnel-emission devices, J. Appl. Phys., 32, 646 (1961) is known.

In the category of surface conduction type emission elements, for example, M. I. Elinson, Radio Eng. Electron Phys., 10, 1290 (1965) and other examples described later are known.

The surface conduction type emission element is based on the utilization of a phenomenon in which electron emission occurs by supplying current to a small-area thin film formed on a substrate in parallel with the film surface. Reported examples of surface conduction type emission element include one using an SnO₂ thin film proposed by Elinson described above, one based on an Au thin film [G. Dittmer: “Thin Solid Films”, 9, 317 (1972)] one based on an In₂O₃/SnO₂ [M. Hartwell], and C. G. Fonstad: “IEEE Trans. ED Conf.” 519 (1975)] and one based on a carbon thin film [H. Araki: Vacuum, vol. 26, no. 1, 22 (1983)].

As a typical element configuration of these surface conduction type emission elements, the plan view of the element proposed by M. Hartwell et al. described above is illustrated in FIG. 16. In FIG. 16, reference numeral 3001 represents a substrate, and 3004, a conductive thin film comprising a metal oxide formed by sputtering. The conductive thin film 3004 is formed into an H-shaped flat surface as shown in the drawing. An electron emitting section 3005 is formed by applying an energizing processing known as an energizing forming described later to this conductive thin film 3004. The distance L in the drawing is within a range from 0.5 to 1 [mm] and W is set as 0.1 [mm]. For convenience of illustration, the electron emitting section 3005 is represented by a rectangle at the center of the conductive thin film 3004. This is however schematic, and does not accurately express the position or the shape of the actual electron emitting section.

In the above-mentioned surface conduction type emission elements including that proposed by M. Hartwell and others, it is a common practice to form an electron emitting section 3005 by applying an energizing processing known as the energizing forming to the conductive thin film 3004 prior to electron emission. More specifically, energizing forming is defined as energizing the conductive thin film 3004 by applying a certain DC voltage or a DC voltage very slowly increasing at a rate of about 1 V/minute to the both ends of the film, causing a local breakage, deformation or deterioration of the conductive thin film 3004, thereby forming an electron emitting section 3005 in an electrically highly resistant state. Cracks occur partially in the locally broken, deformed or deteriorated conductive thin film 3004. When applying an appropriate voltage to the conductive thin film 3004 after the energizing forming, electrons are emitted near the cracks.

The above-mentioned surface conduction type emission elements have a simple structure, providing an advantage of permitting formation of many elements over a wide area. Thus, as disclosed by the present inventor in Japanese Patent Laid-Open No. 64-31332, a method for driving many elements by arrangement is studied.

Regarding applications of surface conduction type emission elements, research efforts have been made on image forming apparatuses such as image display apparatuses and image recording apparatuses, and charged beam sources.

Particularly, in the area of application to image display apparatuses, studies are made on image display apparatuses using a combination of the surface conduction type emission element and a fluorescent member emitting light by irradiation of electro beam, as is disclosed in U.S. Pat. No. 5,066,883 and Japanese Patent Laid-Open No. 2-257551 by the present inventor. The image display apparatus based on the combination of a surface conduction type emission element and a fluorescent member is expected to provide properties more excellent that those of the conventional image display apparatuses based on the other principles. For example, as compared with the liquid crystal display apparatuses having become more popular recently, it is more excellent in that it does not require backlight since it is of the spontaneous emitting type, and has a wider viewing angle.

3. Problems to be Solved by the Invention

The present inventor and others have tried surface conduction type emission elements of various materials, manufacturing processes and constructions including those described above as the prior art. In addition, the inventor and others have studied a multi-electron beam source in which a number of surface conduction type emission elements are arranged, and an image display apparatus based on the application of this multi-beam source.

The present inventor and others have tried, for example, a multi-electron beam source based on an electric wiring method shown in FIG. 17. More specifically, in the multi-electron beam source, many surface conduction type emission elements are two-dimensionally arranged and wired in a matrix shape as shown in the drawing.

In the drawing, reference numeral 4001 schematically represents a surface conduction type emission element as shown in FIG. 16; 4002 represents, a row-direction wiring line; 4003, a column-direction wiring line. The row-direction wiring line 4002 and the column-direction wiring line 4003 have actually a limited electric resistance, but in the drawing, are represented by distribution resistances 4004 and 4005. Such a manner of wiring is referred to as simple matrix wiring.

For the convenience of illustration, a 6×6 matrix is shown, but the scale of the matrix is not of course limited to this. For example, in the case of a multi-electron beam source for an image display apparatus, elements in a number sufficient to perform a desired image display are arranged and wired.

In a multi-electron beam source in which surface conduction type emission elements are simple-matrix-wired, an appropriate electric signal is applied to the row-direction wiring line 4002 and the column-direction wiring line 4003 to ensure desired electron beams. For example, in order to drive surface conduction type emission elements for an arbitrary line in the matrix, a selected voltage Vs is applied to the row-direction wiring line 4002 of the selected line, and simultaneously, a non-selected voltage Vns is applied to the non-selected row wiring line 4002. In synchronization with this, a driving voltage Ve for output of electron beams to the column-direction wiring line 4003 is applied. According to this method, when ignoring the voltage drop caused by the distribution resistances 4004 and 4005, a voltage Ve-Vs is applied to the surface conduction type emission elements of the selected line, and a voltage Ve-Vns is applied to the surface conduction type emission elements of the non-selected line. By selecting appropriate values for the individual voltages Ve, Vs and Vns, electron beams of a desired intensity should be outputted only from the surface conduction type emission elements of the selected line. By applying different driving voltages Ve to the different column-direction wiring lines, electron beams of different intensities should be outputted from each of the elements of the selected line. Since the response speed of the surface conduction type emission element is very high, it should be possible to change the length of time during which the electron beams are outputted by changing the length of time of application of the driving voltage Ve.

The multi-electron beam source in which surface conduction type emission elements are simple-matrix-wired is therefore widely applicable. For example, it is suitably applicable as an electron source for an image display apparatus by appropriately applying an electric signal corresponding to the image information.

However, problems described below have actually been encountered in the multi-electron beam source having simple-matrix-wired surface conduction type emission elements.

When using a multi-electron beam source having simple-matrix-wired surface conduction type emission elements as a large-area image display panel, many driving circuits are required and this has prevented smooth commercialization at low costs. Particularly, the display panel is long in the transverse direction, and RGB stripe arrangement is necessary, leading to the necessity of numerous driving circuits of column wiring line as compared with the number of driving circuits for the row wiring lines, this having also prevented low-cost commercialization.

In view of the above-mentioned problems, it is an object of the present invention to achieve a driving circuit of an image display apparatus with a modulated electron beam source, by low-cost and small-scaled hardware, particularly by a circuit configuration suitable for the tendency toward IC.

4. Means for Solving the Problems

The present invention provides an image display apparatus having a matrix image display panel, wherein the matrix image display panel comprises column wiring lines and row wiring lines, and a column wiring line driver and a row wiring line driver for driving electron emitting elements connected to these column wiring line and row wiring lines; the row wiring driver selectively and sequentially drives the row wiring lines at a horizontal synchronization timing; and the column wiring line driver has a shift register, a latch circuit, a pulse modulating circuit and a column wiring line driving circuit; wherein the shift register transfers image information sequentially, during the horizontal synchronization period, and after the completion of transfer, transfers the same in parallel with the latch circuit; the pulse width modulating circuit outputs modulation signals on the basis of the image information transferred in parallel; the column wiring driving circuit receives output modulated by the pulse width modulating circuit, and drives the electron emission elements connected to the column wiring lines; wherein an output circuit of the column wiring driving circuit comprises a complementary switching circuit (CMOS circuit) and has means for adjusting output impedance to the electron emission elements.

The present invention also provides an image display method which drives a matrix image display panel, wherein the matrix display panel has a row wiring line and a column wiring line, and a row wiring line driver and a column wiring line driver which drive electron emission elements connected to the column wiring line and the row wiring line; selects and drives the row wiring lines sequentially at horizontal synchronization timings by means of the row wiring line driver; sequentially transfers pieces of image information by means of the column wiring line driver within the horizontal synchronization period; transfers all the pieces of image information in parallel to a latch circuit after the completion of transfer; outputs a modulation signal through a pulse width modulating circuit on the basis of the image information transferred in parallel; receives the output of the signal modulated by the pulse width modulating circuit in a column wiring line driving circuit; and drives the electron emission element connected to the column wiring lines; and wherein the output circuit of the column wiring line driving circuit comprises a complementary switching circuit (CMOS circuit); and adjusts an output impedance to the electron emission element.

### EMBODIMENTS

Embodiments of the present invention will now be described in detail with reference to the drawings.

### First Embodiment

A first embodiment will be described. The matrix image display panel used in the image display apparatus of the present invention comprises a multi-electron source having many electron sources such as cold cathode electron emission elements arranged on a substrate, and an image forming member which forms an image by irradiation of electron, arranged oppositely thereto.

Such cold cathode electron emission elements can be formed by accurately positioning on a substrate by using, for example, a manufacturing technology such as photolithographic etching. It is therefore possible to arrange many pieces at slight intervals. Furthermore, as compared with hot cathode conventionally used in CRTs, the cathode itself or surroundings thereof can be driven in a relatively low-temperature state. A multi-electron source can therefore easily be achieved with a smaller arrangement pitch.

In this embodiment of the present invention, the driving method of the matrix image display panel using surface conduction type elements as an electron source will be described.

The embodiment of the present invention will now be described with reference to the drawings.

FIG. 1 illustrates a block diagram of the driving circuit of the image display apparatus of the present invention, and

FIG. 2, a timing chart thereof.

In FIG. 1, reference numeral P2000 represents a matrix image display panel (hereinafter simply referred to as the “display panel”). In this embodiment, 240*720 surface conduction type elements P2001 are matrix-wired vertically by 240 row wiring lines and horizontally by 720 column wiring lines, and electron beams from each surface conduction type elements P2001 are accelerated by a high voltage applied from a high-voltage power supply unit P30. Fluorescence is obtained by the electron beams being irradiated onto a fluorescent member not shown. This fluorescent member not shown can be color-arranged in any of various manners in response to the use. As an example, an RGB upright stripe-shaped color arrangement is used here.

In this embodiment, a case of application where a television image corresponding to a television signal NTSC (National Television System Committee) method is displayed on a display panel having a number of pixels comprising horizontally 240 (RGB trio)*vertically 240 lines is shown below. An image signal having different resolution or frame rate such as a highly precise image of a high definition (HDTV: high definition television) system, or an output signal of a computer can well be coped with, not limited to NTSC, with substantially the same configuration.

P1 represents an NTSC-RGB decoder unit which receives an NTSC-system composite video input and outputs a PGB component. Within this unit of the NTSC-RGB decoder unit P1, a synchronization (SYNC) signal superposed on the input video signal is separated and outputted. Similarly, a color burst signal superposed on the input video signal is separated, and a clock (CLK) signal (CLK1) synchronized with the color burst signal is generated and outputted.

P2 represents a timing generating unit for generating subsequent timing signals necessary for converting an analog RGB signal decoded at the NTSC-RGB decoder unit P1 into a digital graduation signal for brightness-modulating the matrix image display panel P2000.

A clamp pulse for DC-regenerating an RGB analog signal from the NTSC-RGB decoder unit P1 at the analog processing units; a blanking pulse (BLK pulse) for adding a blank period to an RGB analog signal from the NTSC-RGB decoder unit P1 at the analog processing units P3; a detection pulse for detecting the level of an RGB analog signal at the video detecting unit P4 (not shown); a sample pulse (not shown) for converting an RGB analog signal into a digital signal at the A/D unit P6; and a RAM controller control signal necessary for the RAM controller P12 (not shown) to control the RAM P8, are generated within the timing generating unit P2.

Upon entering a CLK1, a self-running CLK signal (CLK2) synchronizing with CLLK1 by the PLL circuit in the timing generating unit P2, a synchronizing signal (SYNC2) generated on the basis of CLK2 within the timing generating unit P2, and self-running CLK2 generating means are provided. Thus, even when an input video signal is not present, CLK2 and SYNC2 which are reference signals can be generated. It is therefore possible to display an image by reading out image data of the RAM means P8.

Reference numeral P3 represents an analog processing unit provided for each of the output primary colors from P1, and mainly performs the following operations. It receives a clamp pulse from the timing generating unit and conducts DC regeneration. It receives a BLK pulse from the timing generating unit P2 and adds a blanking period.

Upon receipt of a gain adjusting signal of the D/A unit P14 which is one of the control outputs of the system control unit composed centering around the MPU 11, it control the amplitude of primary color signals entered from P1.

It also receives an offset adjusting signal of the D/A unit P14 which is one of the control outputs of the system control unit composed around the MPU 11, and performs blank level control of primary color signals entered from P1.

Reference numeral LPFP5 represents prefilter means placed in the first stage of the A/D unit P6.

The A/D unit P6 receives a sample CLK from P2. It is A/D converter means which quantizes analog primary color signals having passed the LPFP5 with the necessary number of graduations.

The inverted γ table P7 is graduation converting means provided for converting an entered video signal into light emitting properties held by the display panel. When expressing a brightness graduation by the pulse width modulation as in this embodiment, a linear feature is often shown in that the amount of emitted light is substantially proportional to the magnitude of brightness data. On the other hand, a video signal processed in a TV image receiver using a CRT is subjected to a γ processing for correcting the non-liner light emitting property of the CRT. Therefore, when causing display of a TV image on a panel having linear light emitting properties as in this embodiment, it is necessary to cancel the effect of γ processing by graduation converting means such as P7.

It is also possible to change the light emitting properties into favorite ones by switching over the table data by means of the output of the I/O control unit P13 which is one of control input/output of a system control unit composed centering around the MPU P11.

Reference numeral P10 represents horizontal 1-line memory means provided for each primary color signal. It rearranges brightness data (image information) entered into the R, G and B systems in parallel into a sequence corresponding to the panel color arrangement, converts the same into a single-system serial signals, and outputs them to the X driver unit via latch means P22.

The system control unit mainly comprises an MPU P1, a serial communication I/F P16, an I/O control unit P13, a D/A unit P14, an A/D unit P15, a data memory P17, and user SW means P18.

The system control unit receives user requests from the user SW means P18 operated by the user or the serial communication I/F P16 receiving control signals operated by instruction by external communication, and achieves the request by outputting the corresponding control signal from the I/O control unit P13 or the D/A unit P14.

In this embodiment, a user request on variability of graduation, brightness, color control and other display control is achievable.

By providing a data memory P17, the amount of user adjustment can be stored.

Reference numeral P19 represents a Y-driver control timing generating unit, and P20, an X-driver control timing generating unit. Both these units generate Y-driver control and X-driver control signals upon receipt of CLK1, CLK2 and SYNC2 signals.

P21 represents a control unit for timing control of the line memory P10, and generates, upon receipt of CLK2 and SYNC2 signals, R, G and B WRT control signals for writing brightness data (image information) into the line memory, and R, G and B RD control signals for reading out brightness data (image information) in a sequence corresponding to the panel color arrangement from the line memory.

T104 shown in FIG. 2 represents a waveform of a color sample data train written with a color from among R, G and B as an example, and comprises 240 data trains for a horizontal period. These data trains are written into the line memory P10 by means of the above-mentioned control signals during one horizontal period. During the next horizontal period, the individual color line memories P10 are read out at a frequency three time as high as that of write and validated, thus obtaining 720 brightness data trains (image information) per a single horizontal period as represented by T105.

P22 represents latching means. This latches an output of the line memory P10 with a slight clock, and synchronizes the data output timing with a desired time.

P1001 represents an X, Y driver timing generating unit. Upon receipt of control signals from the Y-driver control timing generating unit P19 and the X-driver control timing generating unit, it outputs the following signals for X-driver control: a shift clock which sequentially transfers brightness data trains (image information) entered into the shift register circuit P101a; an LD pulse which latches the data transferred by the shift register circuit P1101a in parallel to the latching circuit P1101b (and an LD pulse serving as a trigger for the horizontal period of the PWM generator unit P1102), a shift lock of the horizontal period for operating the Y-shift register P1002 for Y-driver control, and a trigger signal of a vertical period for giving a row scanning starting trigger and outputted.

The shift register circuit P1101a reads in parallel brightness data trains (image information) of 720 column wiring lines for each horizontal period from the latching means P22 by a shift clock in synchronization with the brightness data such as T107 shown in FIG. 2 from the X, Y driver timing generating unit P1001, and converts the same in parallel the 720 data. It latches the same in parallel with the latching circuit P1101b by an LD pulse such as T108, and transfers 720 data for a single horizontal line in a batch to the PWM generator unit P1002.

The PWM generator unit P1102 provided for each column wiring line receives brightness data (image information) from the latching circuit P1101b, and generates pulse signals having a pulse width proportional to the size of brightness data (image information) for each horizontal period with a waveform as shown by T10 in FIG. 2.

P1104 represents a column wiring line driving circuit. Upon receipt of a pulse signal having a pulse width proportional to the size of the brightness data (image data) which is an output of the PWM generator unit P1102, it drives the column wiring line. T111 shown in FIG. 2 represents an example of the column wiring line driving waveform.

Details of the PWM generator unit P1102 and the column wiring line driving circuit P1104 are shown in FIG. 3. Detailed description follows.

The Y-shift register unit P1002 receives a horizontal period shift clock from the X, Y driver timing generating unit P1001 and a vertical period trigger signal for giving a row scanning starting trigger, and outputs sequentially a selection signal for scanning the row wiring line to the pre-driver unit P1003 provided for each row wiring line.

The output unit which drives each row wiring line comprises, for example, FET means P1006, and another FET means P1004. The pre-driver unit P1003 is provided for driving this output unit with a good response. The FET means P1004 is switching means energized upon selecting a row which applies a −Vss potential from the constant-voltage regulator P1005 to the row wiring line upon selection. For example, in the case of the present invention, it takes a value of −10 [V]. The FET means P1006 is switching means energized upon non-selection of a row which drives the row wiring line at 0 [V], becoming the grounding potential upon non-selection. T112 shown in FIG. 2 illustrates an example of the row wiring line driving waveform.

The row wiring lines are sequentially scanned in the above-mentioned manner, and the pulse width is modulated by means of the corresponding image information. The column wiring lines are driven with a driving current value set at an optimum value for each surface conduction type electron emitting element, thus forming an image on the display panel P2000.

The PWM generator unit P1102 and the column wiring line driving circuit P1104 will now be described in detail. Details are illustrated in FIG. 3.

In FIG. 3, P1102a represents an up-counter circuit for entering the clock PCLK serving as a reference for determining a pulse width of PWM not shown into the clock input terminal; and P1102b, a comparator circuit which holds the output on low level until the count output of the up-counter circuit P1102a becomes equal to the output (image information) of the latch circuit P1101d. P1102c, an AND circuit which outputs PCLK to the clock input terminal of the up-counter circuit P1102a only when the output of the comparator circuit P1102b is on a low level. The above-mentioned LD pulse is entered into the synchronization clear terminal, and after input of the LD pulse, the up-counter P1102a counts PCLK. The output of the comparator circuit P1102b becomes a pulse width depending upon the output (image information) of the latch circuit P1101d. P1102d represents a NOT circuit which reverses the output of the comparator circuit P1102b and outputs a high level with a pulse width proportional to the magnitude of the brightness data (image information).

P1104a represents a complementary switching circuit; and P1104b, a resistor of which the resistance value is determined by the display panel.

The complementary switching circuit P1104a is shown in detail in FIG. 4.

In FIG. 4, P1104c represents a NOT circuit; P1104d, a P-type MOSFET; and P1104e, an N-type MOSFET.

In the above-mentioned configuration, for a high-level signal of a pulse width corresponding to the size of brightness data (image information) outputted by the PWM generation unit P1102, the logic level is reversed at the NOT circuit P1104c. The signal is again reverse-outputted by P-type MOSFET P1104d and the N-type MOSFET P1104e which are output circuits, and the source voltage is outputted. In the case of the present invention, upon IC conversion, a source voltage of 5 [V] permitting expectation of a high degree of integrity was used.

The value of the resistor P1104b in the column wiring line driving circuit P1104 is set as follows. By appropriately adjusting the value of this resistor P1104b, the output impedance to the column wiring line can be effectively set.

More specifically, a short period of time is set so as to satisfy the requirement for graduation of the pulse modulation. The capacity of the column wiring line, and other parameters are selected so that driving is possible at a frequency lower than the resonance frequency caused by inductance of the flexible substrate connecting the column wiring line, the display panel P2000 not shown and the column wiring line driving circuit P1104.

When driving the column wiring line with a driving waveform having further frequency components, resonance may occur (hereinafter referred to as “ringing”). In the worst case, ringing causes the driving voltage of the cold cathode element P2001 to surpass the maximum rating value of the element, and may even break the cold cathode element P2001.

For this display panel of about 10″, a value within a range from 100 [Ω] to 1 [kΩ] is optimum for the resistor P1104b. For a large-sized panel of over 30″, a value within a range from 500 [Ω] to 5 [kΩ] was optimum.

In the present invention, the resistor P1104b is arranged in series to the output of the complementary switching circuit P1104a. This may however be replaced by the ON resistance of the P-type MOSFET P1104d and the N-type MOSFET P1104e which are output circuits of the complementary switching circuit P1104a. In this case, the resistor P1104b can of course be deleted, and in addition, the P-type MOSSFET P1104d and the N-type MOSSFET P1104e can be downsized, thus permitting further reduction of area, i.e., cost reduction upon IC conversion.

### Second Embodiment

A second embodiment of the present invention will now be described. In the second embodiment, the column wiring line driving circuit P1104 is different from that in the first embodiment. Since the other configurations are the same as in the first embodiment, description of the configurations other then the column wiring line driving circuit P1104 is omitted here.

The PWM generator unit P1102 and the column wiring line driving circuit P1104 are illustrated in detail in FIG. 5.

In FIG. 5, the PWM generator unit P1102 performs the same operation as in the first embodiment. Description is therefore omitted. As in the first embodiment, the PWM generator unit P1102 outputs the high level with a pulse width proportional to the size of brightness data (image information).

In the column wiring line driving circuit P1104, P1104a represents a complementary switching circuit as in the first embodiment. P1104b represents a resistor for which a resistance value is determined so as to prevent occurrence of winging by the display panel P2000 as in the first embodiment. P1104f represents a switch circuit which is turned on or off through control input. P1106 represents an enable control circuit, comprising a latch circuit P1106a serving as an enable generator as shown in FIG. 6 and an exclusive logical OR circuit P1106b. As shown by T110a in the timing chart of FIG. 7, only rising and trailing of the output T110 of the PWM generator unit P1102 are on LOW level.

In FIG. 6, P1106a represents a latch circuit, and P1106b, an XNOR circuit.

As shown in FIG. 5, the details of the complementary switching circuit P1104a are the same as in the first embodiment, as shown in FIG. 4.

As in the first embodiment, a pulse width high-level signal proportional to the size of the brightness data (image information) outputted by the PWM generator unit P1102 is outputted. In a high-level signal, the logic level is reversed by the NOT circuit P1104c, reversed again and outputted by the P-type MOSFET P1104d and the N-type MOSFET P1104e which are output circuits, and a source voltage is outputted.

In the present invention, a source voltage of 5 [V] permitting expectation of a high degree of integrity in IC conversion is used.

In the above-mentioned configuration, the enable control circuit P1106 time-differentiate the output of the PWM generator unit P1102. More specifically, in the latch circuit P11006a, using PCLK as a clock, the PWM generator unit P1102 latches the output. The latched reversed output is reversed and outputted after exclusive OR of the output of the PWM generator unit P1102 by the XNOR circuit P1106b. As a result, the enable control circuit P1106 low-level-outputs only rising and trailing of the output of the PWM generator unit P1102 as shown by T110a in FIG. 7. The switching circuit P1104f is turned off (open) only when the output of the enable control circuit P1106 is on a low level, and a value dependent on the resistor P1104b is selected as an internal resistance for driving the column wiring line. By appropriately adjusting the value of this resistor P1104b, it is possible to effectively set an output impedance to the column wiring line.

The value dependent on this resistor P1104b provides the following advantages in the following cases (1) and (2).

(1) Upon rising and trailing, the output of the enable control circuit P1106 is on a low level. As in the first embodiment, therefore, the resistor P1104b is placed in series between the complementary switching circuit P1104a and the column wiring line. The column wiring line can be driven without occurrence of ringing.

(2) Since the output of the enable control circuit P1106 is on a high level except upon rising and trailing, the resistor P1104b is short-circuited by the switching circuit P1104f, and the apparatus is less subjected to voltage drop or power loss. The image display panel P2000 could be driven satisfactorily without power loss more than in the first embodiment having shown a satisfactory operation.

The value of the resistor P1104b was selected so that no ringing occurs as in the first embodiment.

In a panel having a display panel of about 10″, a value within a range from 100 [Ω] to 1 [kΩ] was optimum. For a large-sized panel having a size larger than 30″, a value within a range from 500 [Ω] to 5 [kΩ] was optimum.

Ringing occurs when the driving waveform shows an abrupt change. In the second embodiment, in which the driving waveform is more gentle in correspondence only to rising and trailing, it is possible to drive the column wiring lines with a driving waveform free from ringing.

### Third Embodiment

A third embodiment of the present invention will now be described. In the third embodiment, the column-direction column wiring line driving circuit P1104 for the display panel P2000 is different from that in the second embodiment. Since the other configuration is the same as in the second embodiment, description of the configuration other than that of the column wiring line driving circuit P1104 is omitted here.

The PWM generator unit P1102 and the column wiring line driving circuit P1104 of the third embodiment will be illustrated in detail in FIG. 8.

In FIG. 8, the PWM generator unit P1102 operates in the same manner as in the first embodiment. Description is therefore omitted. The PWM generator unit P1102 outputs the high level for a period of the pulse width proportional to the size of the brightness data (image information) as in the first embodiment.

In the column wiring line driving circuit P1104, P1104a represents a complementary switching circuit as in the first embodiment, and P1104b represents, as in the first embodiment, a resistor of which a resistance value depends upon the matrix display panel. P1104g represents a three-state control complementary switching circuit of which the output can be brought into a high impedance state by control input.

P1106 represents an enable control circuit which comprises a configuration as shown in FIG. 6 as in the second embodiment. The description of FIG. 6 is omitted here. The output of the enable control circuit P1106 is on a low level only upon rising and trailing of the output T110 of the PWM generator unit P1102 as shown by T110a in FIG. 7.

The three-state complementary switching circuit P1104g is illustrated in detail in FIG. 9.

In FIG. 9, P11104h represents a knot circuit, P1104i, a NAND circuit, P1104j, a NOR circuit, P1104k, a P-type MOSFET, and P1104m, an N-type MOSFET.

In FIG. 9, the NAND circuit P1104i and the NOR circuit P1104j output a reversed input only when the enable terminal is on a high level, and reversed and outputted again by the P-type MOSFET P1104d and the N-type MOSFET P1104e, and a source voltage is outputted to the output terminal. When the enable terminal is on a low level, outputs of the NAND circuit P1104i and the NOR circuit P1104j are fixed on a high level and a low level, respectively, irrespective of the input. Both the P-type MOSSSFET P1104d and the N-type MOSFET P1104e are pinched off, and the result thereof becomes a high impedance.

In the present invention, a source voltage of 5 [V] permitting expectation of a high degree of integration upon IC conversion was used.

In the above-mentioned configuration, the enable control circuit P1106 outputs a waveform resulting from the time differentiation of the output by the PWM generator unit P1102 as in the second embodiment. That is, in FIG. 7, as shown by T110a, the PWM generator unit P1102 outputs a low level only upon rising and trailing of output.

The three-state complementary switching circuit P1104g is in a high-impedance state only when the output of the PWM generator unit P1102 is on a LOW level.

Since the complementary witching circuit P1104a and the three-state complementary switching circuit P1104g are connected in parallel,

(1) Upon raising and trailing, output of the enable control circuit P1106 is on a low level (because the enable input of the three-state complementary switching circuit P1104g is on a low level and the output of the three-state complementary switching circuit P1104g is of a high impedance). It is therefore possible to drive the column wiring line by means of the complementary switching circuit P1104a and the serial circuit of the resistance P1104b. It is thus possible to drive the column wiring line without occurrence of ringing.

(2) Furthermore, since at times other than rising and trailing times, the output of the enable control circuit P1106 is on a high level (as the enable input of the three-state complementary switching circuit P1104g is on a high level and the output of the three-state complementary switching circuit P1104g is valid), the column wiring lines are driven by the output impedance based on parallel connected of the complementary switching circuit P1104a and the three-state complementary switching circuit P1104g, thus leading to only slight voltage drop and power loss. These advantages are available. The image display panel P2000 could be driven more satisfactorily than in the first embodiment showing a good operation.

In a panel of about 10″, as in the first embodiment, a value of the resistor P1104b within a range from 100 [Ω]to 1 [kΩ] was optimum. For a large-sized panel larger than 30″, a value within a range from 500 [Ω] to 5 [Ω] was optimum.

In the present invention, the resistor P1104b is arranged in series with the output of the complementary switching circuit P1104a. This may be replaced by an ON resistance of the P-type MOSFET P1104d and the N-type MOSFET P1104e which are output circuits of the complementary switching circuit P1104a. In this case, it is of course possible to delete the resistor P1104b, and downsize the P-type MOSFET P11104d and the N-type MOSFET P1104e, thus permitting further reduction of area, i.e., cost reduction upon IC conversion.

### Fourth Embodiment

A fourth embodiment of the present invention will now be described. In the fourth embodiment, column wiring line driving circuit P1104 in the column direction for the display panel P2000 is different from that in the third embodiment. Since the other configuration is the same, the description of the configuration other than the column wiring line driving circuit P1104 is omitted here.

The PWM generator unit P1102 and the column wiring line driving circuit P1104 are shown in detail in FIG. 10.

In FIG. 10, the PWM generator circuit P1102 operates in the same manner as in the first embodiment. Description is therefore omitted. As in the first embodiment, the PWM generator unit P1102 outputs the time high level of a pulse width proportional to the size of the brightness data (image information).

In the column wiring line driving circuit P1104, reference numerals P1104g1 and P1104g2 represent three-state complementary switching circuits which can bring the output to a high impedance state by a control input. Since the details of the three-state complementary switching circuits P1104g1 and P1104g2 have the same configuration as the three-state complementary switching circuit P1104g described in FIG. 8, the description thereof is omitted here.

P1104b represents a resistor having a resistance value determined by the same matrix display panel as in the first embodiment.

P1106 represents an enable control circuit which comprises a configuration as shown in FIG. 11. As shown by T110a and T110b in the timing chart illustrated in FIG. 12, only rising and trailing of the output T110 of the PWM generator unit P1102 exhibit a low level and a high level, respectively.

The output of the enable control circuit P1106 is such that, in FIG. 7, the output T110 of the PWM generator unit P1102 becomes a low level or a high level, as shown by T110a and T110b, only upon rising and trailing.

In FIG. 11, P1106a represents a latch circuit, P1106c, an XOR circuit, and P1106d, a NOT circuit.

In the present invention, a source voltage of 5 [V] permitting expectation of a high degree of integration upon IC conversion is used.

In the above-mentioned configuration, the enable control circuit P1106 time-differentiates the output of the PWM generator unit P1102. That is, PCLK is used as a clock at the latch circuit P1106a; the PWM generator unit P1102 latches the output; and after exclusive OR by the XOR circuit P1106c of the output, the latched reverse output and the PWM generator unit P1102 outputs the same (T110b). The NOT circuit P1106d reverse-outputs this output (T110a). As a result, as shown in FIG. 12, the enable control circuit P1106 outputs a signal (T110a) causing output of a low level only upon rising and trailing of output of the PWM generator unit P1102 and a reversed output thereof (T110b). Consequently, the following advantages (1) and (2) are obtained.

(1) Upon rising and trailing, the enable control circuit P1106 outputs a high-level enable signal to the three-state complementary switching circuit P1104g1, and a low-level enable signal to the three-state complementary switching circuit P1104g2, respectively. As a result, the three-state complementary switching circuit P1104g2 gives a high-impedance output and does not exert an influence on the column wiring line driving. On the other hand, the three-state complementary switching circuit P1104g1 outputs the output of the PWM generator unit P1102 as it is.

Since a resistance P1104b is connected in series between the three-state complementary switching circuit P1104g1 and the column wiring line, the column wiring line can be driven with a driving waveform free from ringing.

(2) At other times than rising and trailing, the enable control circuit P1106 outputs a low-level enable signal to the three-state complementary switching circuit P1104g1, and a high-level enable signal to the three-state complementary switching circuit P1104g2, respectively. As a result, the three-state complementary switching circuit P1104g1 gives a high-impedance output, and does not exert an influence on the column wiring line driving. On the other hand, the three-state complementary switching circuit P1104g2 outputs the output of the PWM generator unit P1102 as it is. By this output, the three-state complementary switching circuit P1104g2 drives the column wiring line at a low impedance, leading to such advantages as slight voltage drop and power loss. The image display panel P2000 could be driven satisfactorily more than the first embodiment which was satisfactory.

For a display panel of about 10″, a value of the resistor P1104b within a range from 100 [Ω] to 1 [kΩ] was optimum. For a large-sized panel larger than 30″, a value within a range from 500 [Ω] to 5 [kΩ] was optimum.

In the present invention, the resistor P1104b is arranged in series with the output of the complementary switching circuit P1104a. This may be replaced by an ON resistance of the P-type MOSFET P1104d and the N-type MOSFET P1104e which are output circuits of the complementary switching circuit P1104a. In this case, the resistor P104b can of course be deleted, and the P-type MOSFET P1104d and the N-type MOSFET P1104e can be downsized, thus permitting achievement of further reduction of the area, i.e., reduction of cost upon IC conversion.

### Fifth Embodiment

A fifth embodiment of the present invention will now be described. In the fifth embodiment, three or more three-state complementary switching circuits are connected in parallel in the fourth embodiment.

In FIG. 13, the PWM generator unit P1102 operates in the same manner as in the first embodiment. The description is therefore omitted here. The PWM generator unit P1102 outputs time high level of the pulse width proportional to the size of brightness data (image information) as in the first embodiment).

In the column wiring line driving circuit P1104, reference numeral P1104a represents a complementary switching circuit as in the first embodiment, and P1104b1, a first resistor of which a resistance value is determined by the matrix display panel as in the first embodiment. P1104g1 represents a three-state complementary switching circuit of which the output can be brought into a high-impedance state by enable input. P1104b2 represents a second resistor of which the resistance value is determined by the matrix display panel, as in the first embodiment.

P1104g2 represents a three-state complementary switching circuit of which the output can be brought into a high0impedance state by enable input.

P1106 represents an enable control circuit which outputs two kinds of enable outputs including T110c and T110d shown in FIG. 14, although the description of the configuration is omitted here.

The output of the enable control circuit P1106, as shown by T110c and T110d in FIG. 14, becomes low level only upon rising and trailing of the output T110 of the PWM generator unit P1102.

The low level period of T110c and T110d has a relationship T110c<T110d.

Detailed description of the complementary switching circuit P1104a, and the three-state complementary switching circuit P1104g1 and P1104g2 is omitted here, being the same as in the above-mentioned embodiments.

In the present invention, a source voltage of 5 [V] permitting expectation of a high degree of integration upon IC conversion. This embodiment provides the following advantages (1) and (2).

(1) Upon rising and trailing (i), both outputs of the enable control circuit P1106 (both T110c and T110d) are on a low-level (enable input of the three-state complementary switching circuits P1104g1 and P1104g2 are on a low level, and outputs of the three-state complementary switching circuits P1104g1 and P111104g2 show a high impedance). The column wiring line can therefore be driven by the serial circuit of the complementary switching circuit P1104a and the resistor P1104b1, thus permitting driving of the column wiring line without occurrence of ringing.

(2) Upon rising and trailing (ii), and further, after the lapse of a time, output T110c of the enable control circuit P1106 is on a low level and output 110d thereof is on a high level (since the enable input of the three-state complementary switching circuit P1104g1 is on a high level, and the output of the three-state complementary switching circuit P110g2 is valid). Therefore, the output impedance is substantially equal to the parallel-connection value of the resistor P1104b1 and the resistor P1104b2, and this is sufficient to drive the column wiring line. It is therefore possible to drive the column wiring line without occurrence of ringing without slowing down the rising (trailing) waveform too much when the potential difference between the source voltage and the column wiring line voltage is reduced.

(3) At times other than rising and trailing, outputs of the enable control circuit P1106 (T110c, T110d) are on a high level (because the enable input of the three-state complementary switching circuits P1104g1 and P1104g2 is on a high level, and the output of the three-state complementary switching circuits P1104g1 and P1104g2 is valid). The column wiring line is driven by means of a parallel-connection circuit of the complementary switching circuit P1104a and the three-state complementary switching circuits P1104g1 and P1104g2, i.e., the column wiring line is driven by the output of the three-state complementary switching circuit P1104g2, thus resulting in such advantages as reduced voltage drop and power loss. The image display panel P2000 could thus be driven more satisfactorily than in the fourth embodiment showing satisfactory operation.

For the resistor P1104b1, a value within a range from 100 [Ω] to 2 [kΩ] was optimum for a panel of about 10″ as in the first embodiment. For a large-sized panel larger than 30″, a value within a range from 500 [Ω] to 10 [kΩ] was optimum.

A value of the resistor P1104b2 within a range from 20 [Ω] to 1 [kΩ] was optimum for a display panel of about 10″. For a large-sized panel of over 30″, a value within a range from 100 [Ω] to 5 [kΩ] was optimum.

In the present invention, the resistor P1104b1 is arranged in series with the output of the complementary switching circuit P1104a. This may however be replaced by an ON resistance of the P-type MOSFET P1104d and M-type MOSFET P1104e which are output circuits of the complementary switching circuit P1104a. Moreover, the resistor P1104b2 may be replaced by an ON resistance of a P-type MOSFET P1104k and an N-type MOSFET P1104m which are output circuits of the three-state complementary switching circuit P1104g1. In this case, the resistors P1104b1 and P1104b2 can be of course deleted, and further, the P-type MOSFETs P11042 and P1104k, and the N-type MOSFETs P1104e and P1104m can be downsized, thus permitting reduction of area, hence cost reduction upon IC conversion.

### Sixth Embodiment

FIG. 15 illustrates a case of display apparatus configured so that image information provided by various image information sources including those from television broadcasting circles can be displayed on a display panel using the above-mentioned surface conduction type emission elements as an electron beam source.

In FIG. 15, reference numeral 2100 represents a display panel forming an image by emitting electrons from electron emission elements onto a fluorescent member not shown as in the above-mentioned display panel P2000; 2101, a driving circuit for the display panel 2100; 2102, a display controller; 2103, multiplexor; 22104, a decoder; 2105, input/output interface circuit; 2108, 2109 and 2110, image memory interface circuits; 2111, an image input interface circuit; 2112 and 2113, TV signal receiving circuits; and 2114, an input unit. When receiving signals including both image information and audio information as in TV signals, this display apparatus regenerates voice at the same time as images. Description will however be omitted about circuits regarding receiving, separation, regeneration, processing and storage which have not direct relationship with the features of the present invention and the speaker.

The functions of various parts and components will now be described along the flow of image signals.

The TV signal receiving circuit 2113 is a circuit for receiving TV image signals transmitted by the use of a radio transmission system such as electromagnetic waves or space optical communication. The type of TV signals received is not limited to a particular one but may be any of various types including, for example, NTSC, PAL, and SECAM. TV signals comprising more scanning lines than those described above (including so-called high-definition TV such as MUSE method) are signal sources suitable for effective use of advantages of the above-mentioned display panel well adaptable to achievement of a larger area and increase in the number of pixels. TV signals received by the TV signal receiving circuit 2113 are outputted to the decoder 2104.

The TV signal receiving circuit 2112 is a circuit for receiving TV image signals transmitted by means of a CATV system such as a coaxial cable or an optical fiber. As in the above-mentioned TV signal receiving circuit 2113, the type of received TV signals is not limited to a particular one, and TV signals received by this circuit are also outputted to the decoder 2104.

The image input interface circuit 2111 is a circuit for incorporating image signals supplied from image input apparatuses such as a TV camera and an image reading scanner. Image signals incorporated are outputted to the decoder 2104.

The image memory interface circuit 2110 is a circuit for incorporating image signals stored in a video tape recorder (hereinafter abbreviated as a “VTR”), and the incorporated image signals are outputted to the decoder 2104.

The image memory interface circuit 2109 is a circuit for incorporating image signals stored in the video disk, and the incorporated image signals are outputted to the decoder 2104.

The image interface circuit 2108 is a circuit for incorporating image signals from the apparatus storing still image data as in a still image disk, and the incorporated still image data are outputted to the decoder 2104.

The input/output interface circuit 2105 is a circuit for connecting this display apparatus to an external computer or a computer network or an output unit such as a printer. It conducts input/output of image data or characters or graphic information and in some cases, can perform input/output control signals and numerical data between the CPU 2106 provided in this display apparatus and an external device.

The image generating circuit 2107 is a circuit for generating image data or character and graphic information entered from outside via the above-mentioned input-output interface circuit 2105, or image data and character and graphic information outputted from the CPU 2106. In this circuit, there are incorporated a rewritable memory for storing image data or character and graphic information, a read-only memory storing image patterns corresponding to character codes, and circuits necessary for generating images including processors for carrying out image processing. The image data for display generated by this circuit are outputted to the decoder 2104, and as required, can be outputted to an external computer network or a printer via the above-mentioned input/output interface circuit 2105.

The CPU 2106 carries out mainly operational control of this display apparatus and operations relating to generation, selection or edition of displayed images.

For example, the CPU outputs control signals to the multiplexer 2103, and appropriately selects or combines image signals to be displayed on the display panel. It generates control signals to the display panel controller 2102 in response to the image signals to be displayed, and appropriately controls operations of the display apparatus such as the screen display frequency, the scanning method (for example, interlace or non-interlace), or the number of scanning lines per screen. It directly outputs image or character and graphic information to the image generating circuit 2107, or accesses an external computer or a memory via the input/output interface circuit 2105 to enter image data or character or graphic information.

The CPU 2106 may if course be engaged in operation for other purposes. For example, it may directly participate in functions generating or processing information as a personal computer or a wordprocessor.

It may perform such operations as numerical calculation in cooperation with an external device through connection with an external computer network via the input/output interface 2105 as described above.

The input unit 2114 is for the user to enter an instruction, a program or data into the CPU 2106, and it is possible to use various input devices such as a joy stick, a barcode reader and voice recognizer, in addition to a keyboard and a mouse.

The decoder 2104 is a circuit for reverse-converting various image signals entered from above-mentioned 2107 to 2113 into three primary color signals, or a brightness signal and an I-signal or a Q-signal. As shown by a dotted line in this drawing, the decoder 2104 should preferably have an image memory in the interior. This is to handle TV signals requiring an image memory upon reverse-converting as in the MUSE method. By having an image memory, display of a still image becomes easier. Another advantage is that image processing or edition including thinning, interpolation, enlargement, size reduction and synthesis of images becomes easier in cooperation with the image generating circuit 2107 and the CPU 2106.

The multiplexer 2103 appropriately selects displayed images in accordance with a control signal control from the CPU 2106. More specifically, the multiplexer 2103 selects desired image signals from among reverse-converted image signals entered from the decoder, and enters the selected image signal to the driving circuit 2101. In this case, it is possible to divide a screen into a plurality of regions to display different images as in the so-called multi-screen television set by selecting while switching image signals within a screen display time.

The display panel controller 2102 is a circuit for controlling the operation of the driving circuit 2101 on the basis of control signals entered from the CPU 2106.

Regarding the basic operations of the display panel 2100, for example, it outputs signals for controlling the operating sequence of the driving power supply (not shown) of the display panel 2100 to the driving circuit 2101.

Regarding the driving method of the display panel 2100, it outputs signals for controlling the image display frequency or the scanning method (for example, interlace or non-interlace) to the driving circuit 2101.

As required, it may output control signals regarding adjustment of the image quality such as brightness of the displayed image, contrast, color tone and sharpness, to the driving circuit 2101.

The driving circuit 2101 is a circuit for generating driving signals to be applied to the display panel 2100, and operates on the basis of an image signal entered from the multiplexer 2103 and a control signal entered from the display panel controller 2102.

The functions of the parts and components have been described above. Under the effect of the typical configuration shown in FIG. 15, in this display apparatus, it is possible to display image information entered from various image information sources onto the display panel 2100.

More specifically, various image signals including those of television broadcasting are reversely converted in the decoder 2104, then, appropriately selected at the multiplexer 2103, and are entered into the driving circuit 2101. On the other hand, the display controller 2102 generates control signals for controlling operations of the driving circuit 2101 in response to the image signal to be displayed. The driving circuit 2101 applies a driving signal to the display panel 2100 on the basis of the image signal and the control signal.

As a result, an image is displayed on the display panel 2100. These series of operations are comprehensively controlled by the CPU 2106.

In this display apparatus, an image selected from among a plurality of pieces of image information is displayed by the participation of the image memory built in the decoder 2104, and image generating circuit 2107 and the CPU 2106. Furthermore, it is possible to apply image processing operations including enlargement, reduction, turning, moving, edge enhancement, thinning, interpolation, color conversion, and change of aspect ratio of image, and image editing operations such as synthesis, erasure, connection, replacement, and fitting. Although it has not been specifically pointed out in the description of the embodiments, special circuits for processing or edition also for audio information may be provided.

This display apparatus can have in a single machine functions of a display device for television broadcasting, a terminal machine for TV conference, an image editing device handling still images and animations, a terminal device of a computer, a word processor and other office terminals, and a game machine, and is very widely applicable for industrial and non-industrial purposes.

The above-mentioned FIG. 15 illustrates only some examples of the configuration of the display apparatus using the display panel having surface conduction type emitting elements as an electron beam source. Its configuration is not of course limited to these examples. For example, from among the component elements shown in FIG. 15, circuits for functions not necessary for the purposes of use may be omitted. In contrast, further component elements may be added for purposes of use. For example, when this display apparatus is applied as a TV telephone, it would be appropriate to add a TV camera, a voice microphone, an illumination device, transmitting and receiving circuits including a modem to the component elements.

In this display apparatus, it is possible to reduce the depth of the entire apparatus since the display panel having surface conduction type emission elements as an electron beam source can be made thinner. In addition, the display panel having surface conduction type emission elements as an electron beam source can easily have a larger screen, with a high brightness and excellent viewing angle properties. This display apparatus can therefore display a powerful image rich in feeling of presence with a high visual recognizability.

### ADVANTAGES

As described above, in the image display apparatus of the present invention, i.e., in the apparatus having a matrix image display panel having column and row wiring lines, a row wiring line driver and a column wiring line driver which drive the column wiring lines and the row wiring lines, the row wiring line driver sequentially selects and drives the row wiring lines at a horizontal synchronization timing. In this case, the column wiring line driver has a shift register, a latch circuit, a pulse width modulating circuit, and a column wiring line driving circuit. Within the horizontal synchronization period, the shift register sequentially transfers pieces of image information. After the completion of transfer, the image information is transferred in parallel with the latch circuit, and the pulse width modulating circuit outputs a modulation signal on the basis of the image information transferred in parallel. Upon receipt of output of the modulation signal modulated by the pulse width modulating circuit, the column wiring line driving circuit drives the column wiring line. The output circuit of the column wiring line driving circuit comprises a complementary switching circuit (CMOS circuit), thus having means for adjusting the output impedance. As a result, when using a multi-electron beam source in which surface conduction type emission elements are simple-matrix wired as a large-area image display panel, the column wiring line driving circuit so far prevented smooth commercialization at a low cost can drive a large-area display panel at a low cost without the risk ringing.

In the conventional display apparatus, requiring a stripe arrangement, the number of driving circuits of column wiring lines has been very large as compared with the number of row wiring line driving circuits, and this prevented smooth commercialization at a low cost. According to the present invention, it is possible to achieve a high degree of integration, particularly upon IC conversion, of the driving circuits of the image display apparatus of modulating the electron beam source.

### BRIEF DESCRIPTION OF THE DRAWINGS

FIG. 1 is a configuration view illustrating an embodiment of the image display apparatus of the present invention.

FIG. 2 is a timing chart of a first embodiment of the present invention.

FIG. 3 illustrates details of a PWM generator and a column wiring line driving circuit of the first embodiment of the present invention.

FIG. 4 illustrates details of the complementary switching circuit of the first embodiment of the present invention.

FIG. 5 illustrates details of the PWM generator and the column wiring line driving circuit of a second embodiment of the present invention.

FIG. 6 illustrates details of an enable control circuit of the second embodiment of the present invention.

FIG. 7 is a timing chart of the second embodiment of the present invention.

FIG. 8 illustrates details of a PWM generator and a column wiring line driving circuit of a third embodiment of the present invention.

FIG. 9 illustrates details of the three-state complementary switching circuit of the third embodiment of the present invention.

FIG. 10 illustrates details of a PWM generator and a column wiring line driving circuit of the fourth embodiment of the present invention.

FIG. 11 illustrates details of the PWM generator and the column wiring line driving circuit of the fourth embodiment of the present invention.

FIG. 12 is a timing chart of the fourth embodiment of the present invention.

FIG. 13 illustrates details of a PWM generator and a column wiring line driving circuit of a fifth embodiment of the present invention.

FIG. 14 is a timing chart of the fifth embodiment of the present invention.

FIG. 15 is a block diagram of the multi-function image display apparatus using the image display apparatus of an embodiment of the present invention.

FIG. 16 is a plan view of a conventional element proposed by M. Hartwell.

FIG. 17 illustrates problems in an electron beam source in which wiring is in a matrix shape.

### REFERENCE NUMERALS

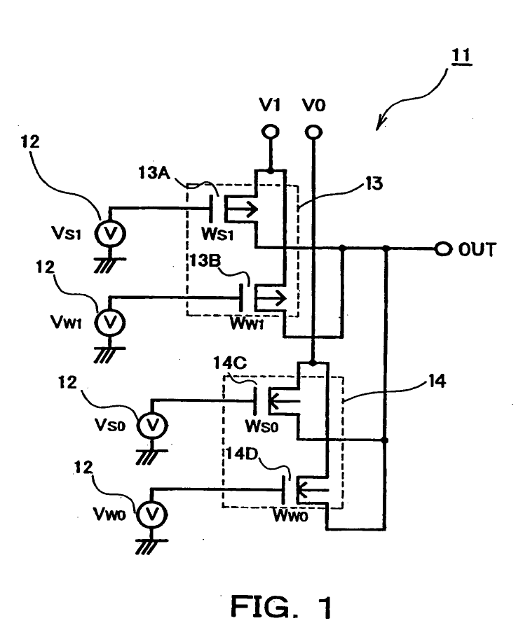

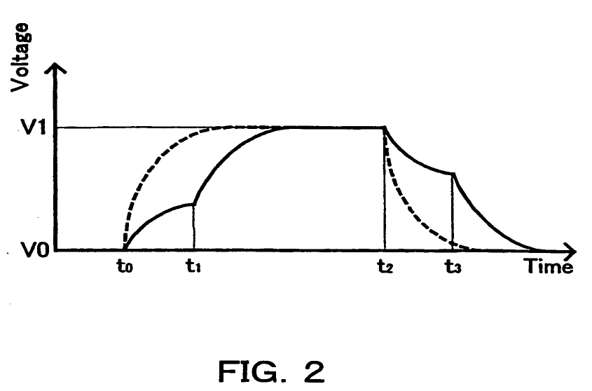

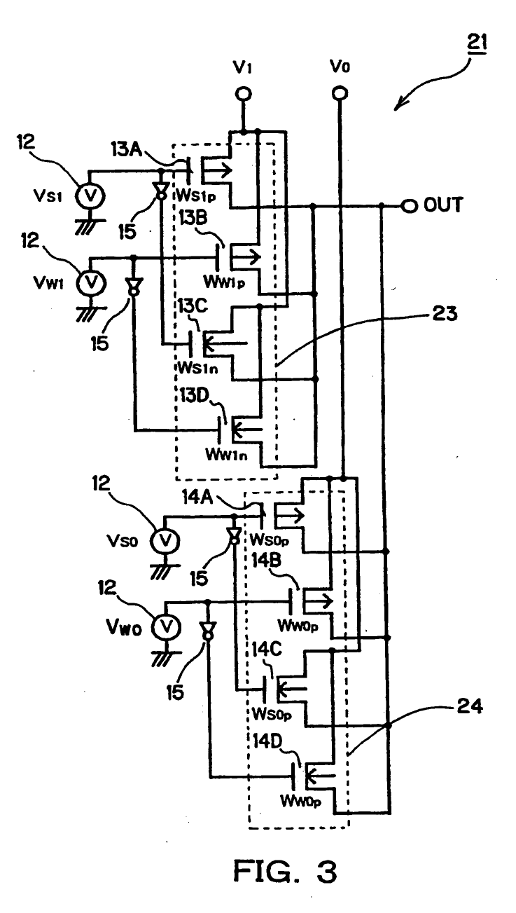

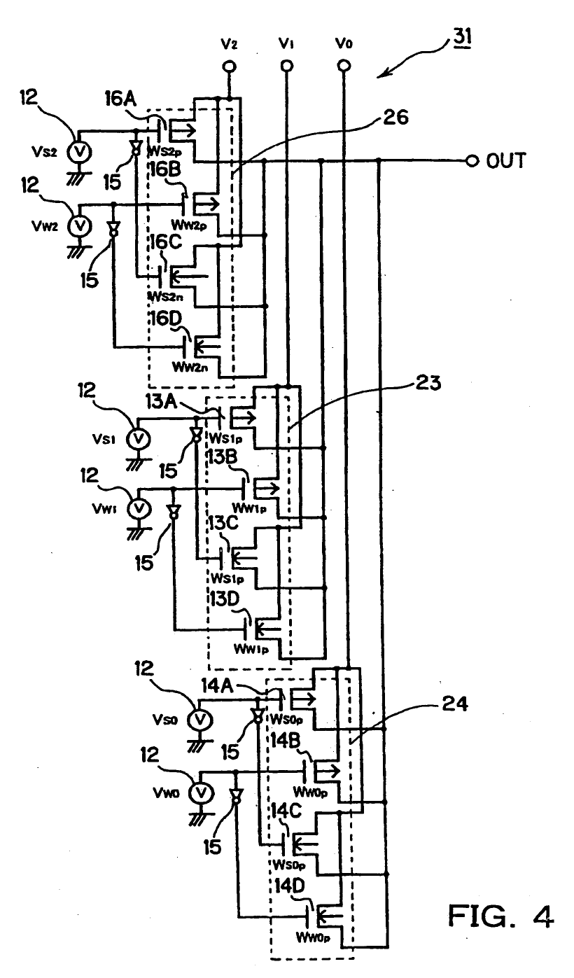

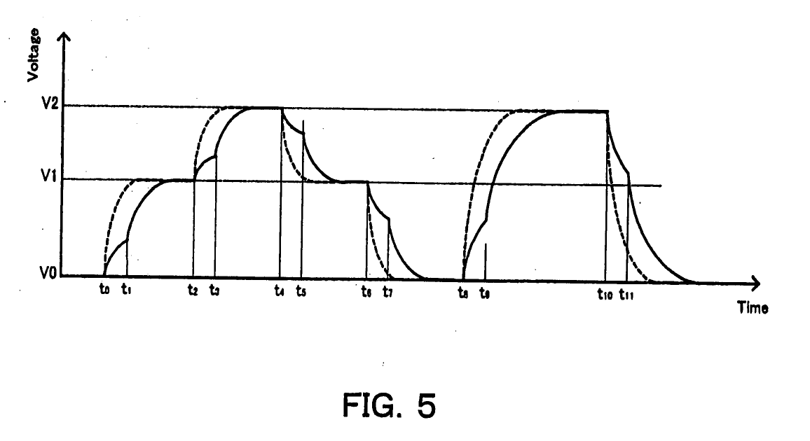

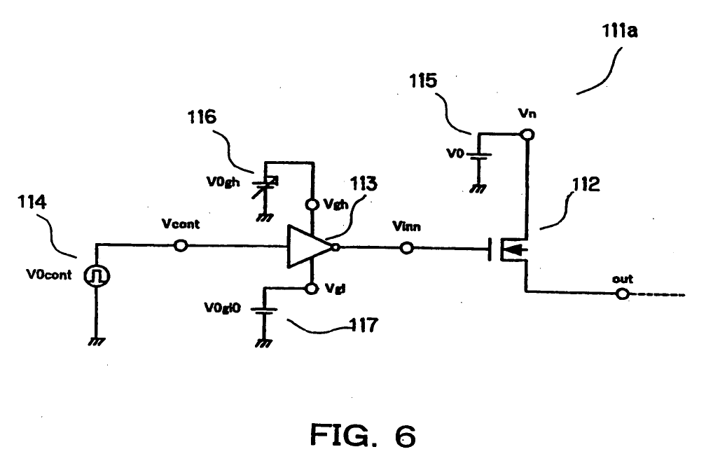

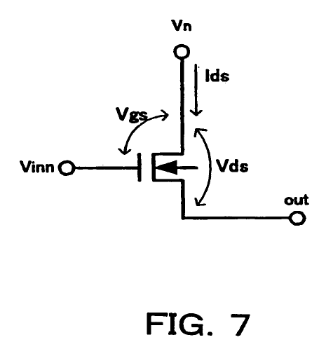

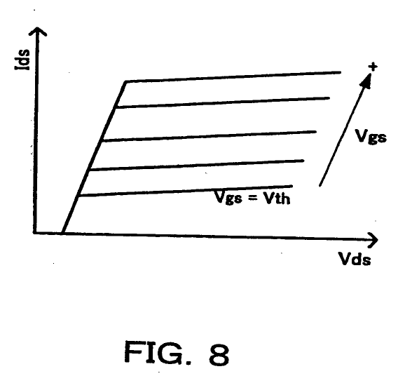

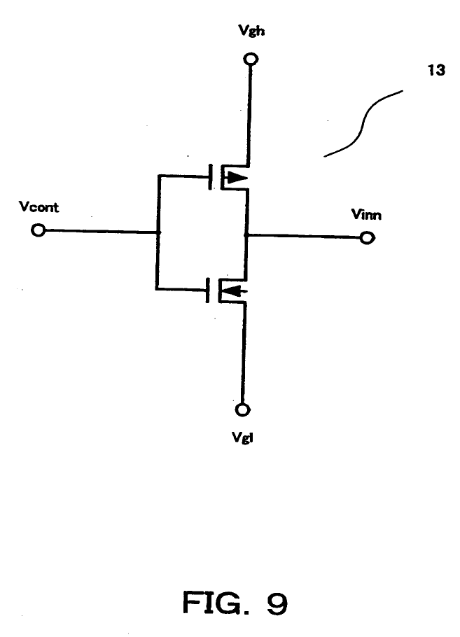

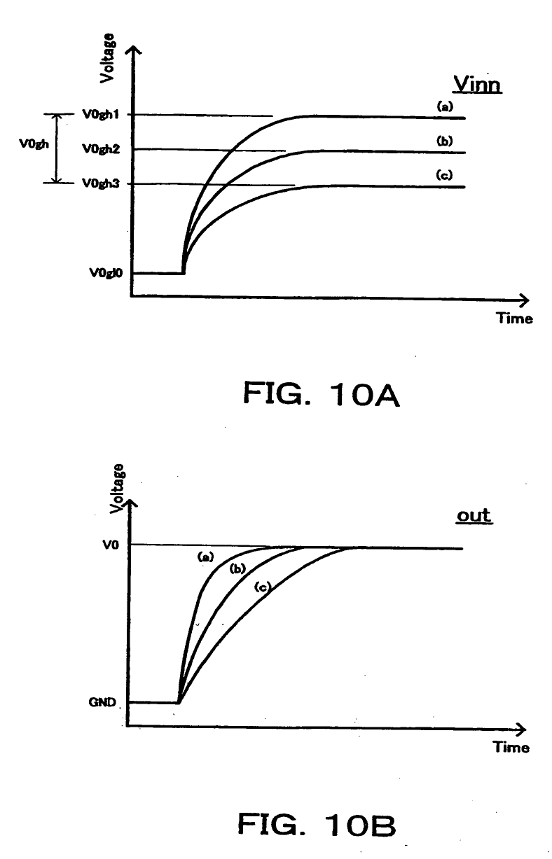

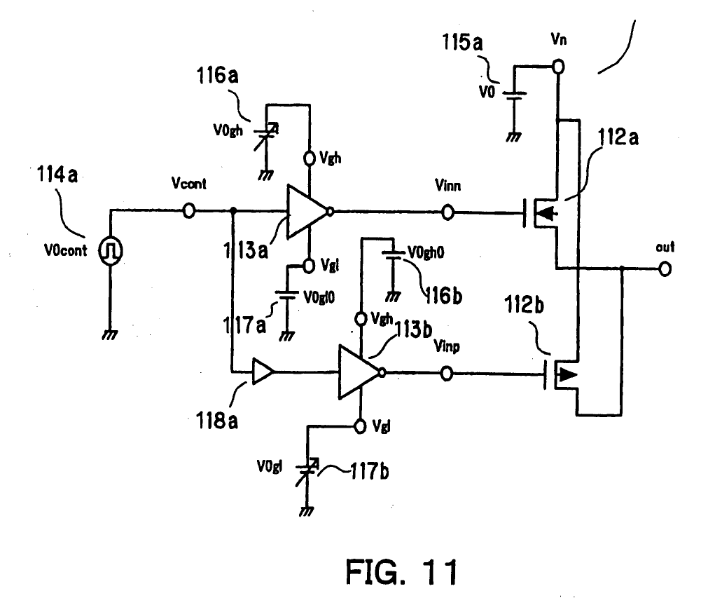

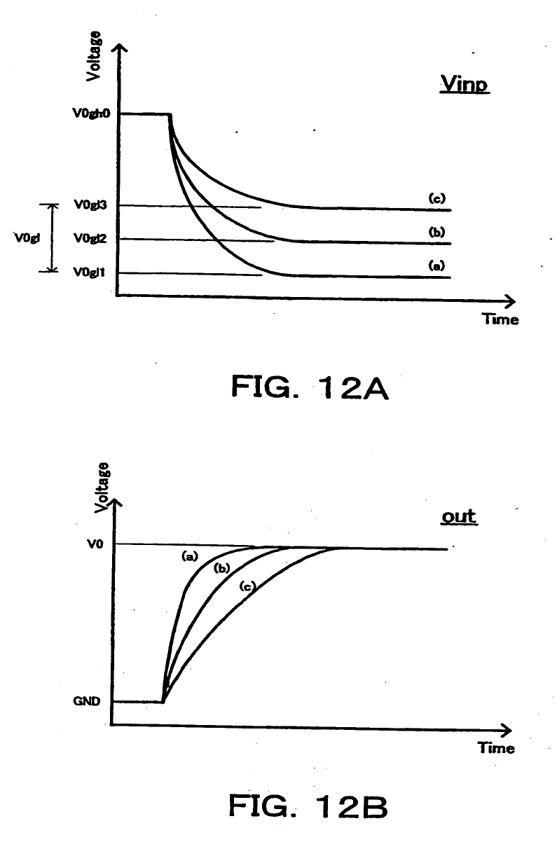

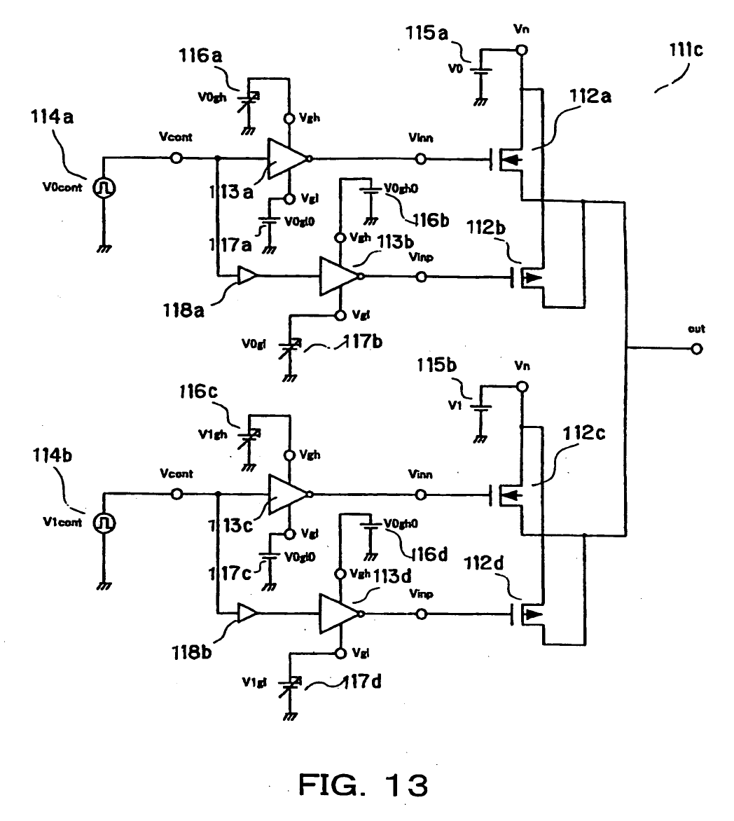

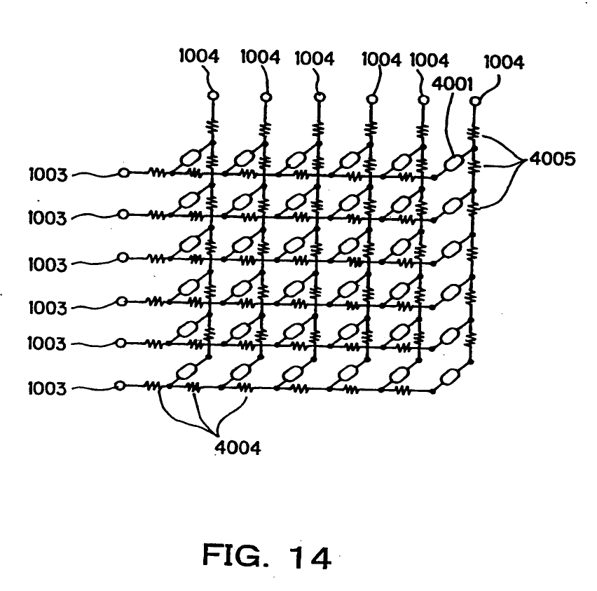

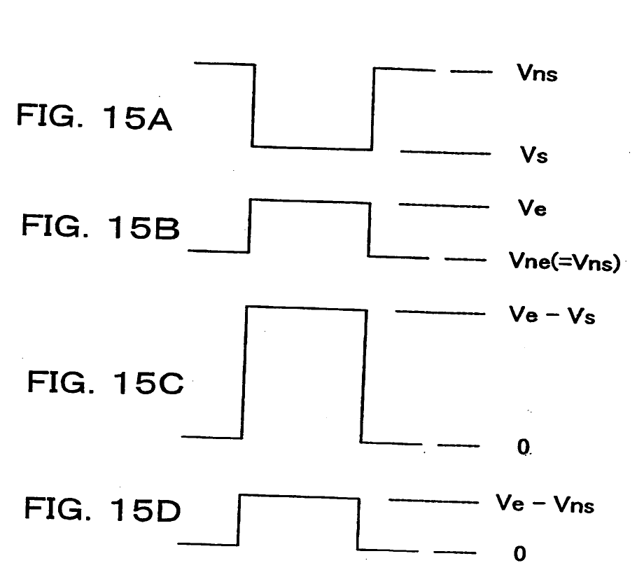

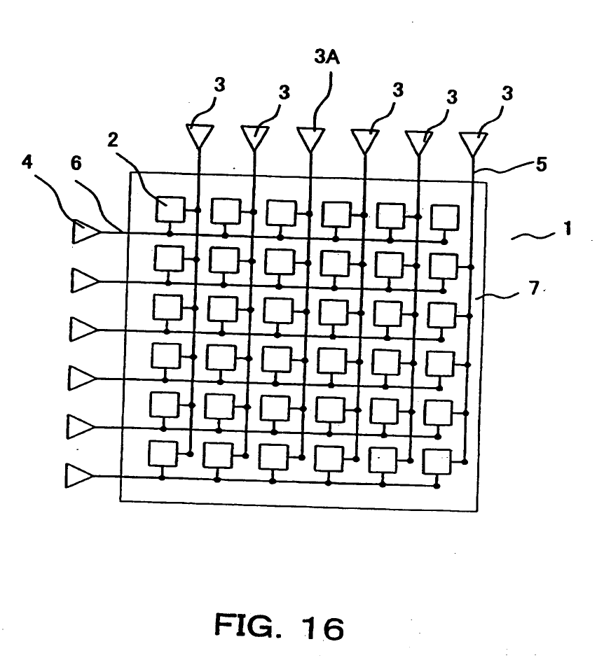

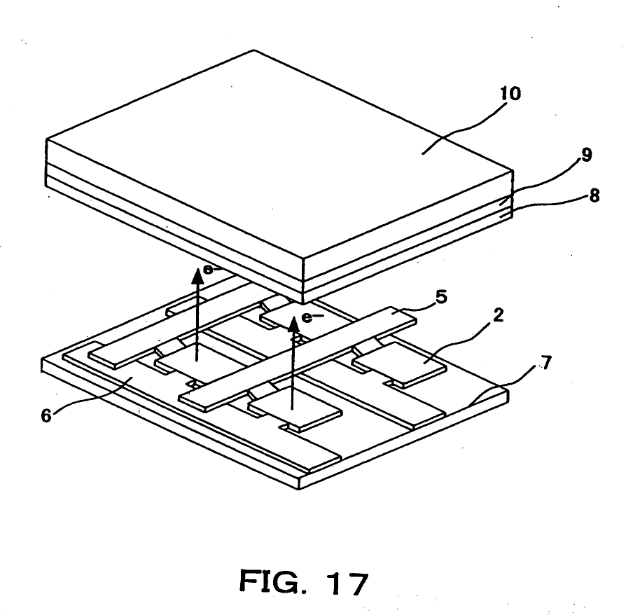

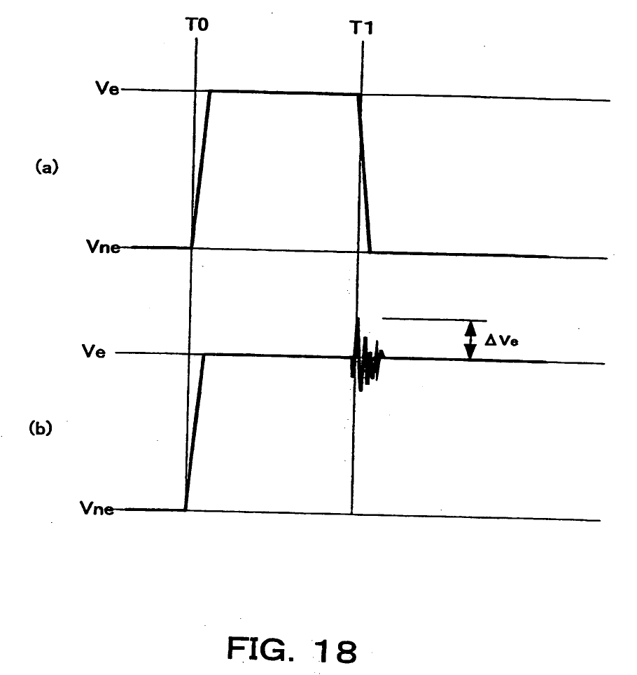

P1: NTSC-RGB decoder unit
P2: Timing generating unit
P3: Analog processing unit
P4: Video detecting unit
P5: Pre-filter means (LPF)
P6: LPF: A/D converter means (A/D unit) which quantize analog primary color signals having passed LPF and P5 by means of the necessary number of graduations
P7: Inverted γ table
P10: Line memory means
P11: MPU
P13: I/O control unit
P14: D/A unit
P16: Serial communication I/F
P17: Data memory
P18: User SW means
P19: Y-driver control timing generating means
P20: X-driver control timing generating means
P21: Line memory control unit
P22: Latching means
P30: High-voltage power supply unit
P1001: X, Y driver timing generating unit
P1002: Y-shift register unit
P1003: Pre-driver unit
P1004: FET means
P1005: Constant-voltage regulator unit (−Vss)
P1006: FET means
P1101a: Shift register circuit
P1101b: Latch circuit
P1102: PWM generator unit
P1102a: Up-counter circuit
P1102b: Comparator circuit
P1102c: AND circuit
P1104: Column wiring line driving circuit
P1104a: Complementary switching circuit
P1104b: Resistor
P1104b1: Resistor
P1104b2: Resistor
P1104f: Switch circuit
P1104g: Three-state complementary switching circuit
P1104g1: Three-state complementary switching circuit
P1104g2: Three-state complementary switching circuit
P1106: Enable control circuit
P2000: Display panel
P2001: Surface conduction type emission element
P2002: Row wiring line
P2003: Column wiring line
   FIG. 1
(1) DECODER UNIT
(2) TIMING GENERATING UNIT
(3) RAM CONTROLLER CONTROL SIGNAL
(4) HIGH-VOLTAGE POWER SUPPLY UNIT
(5) TO EXTERNAL HOST
(6) SERIAL COMMUNICATION I/F
(7) CLAMP PULSE
(8) BLK PULSE
(9) Y-DRIVER CONTROL TIMING GENERATING UNIT
(10) PRE-DRIVER
(11) DATA MEMORY
(12) Y-DRIVER CONTROL
(14) X-DRIVER CONTROL
(16) R.G.B. WRT CONTROL
(17) R.G.B. RD CONTROL
(18) X-DRIVER CONTROL TIMING GENERATING UNIT
(19) LINE MEMORY CONTROL UNIT
(20) Y SHIFT REGISTER
(21) DISPLAY PANEL
(22) RGB OFFSET ADJUSTMENT
(23) RGB GAIN ADJUSTMENT
(24) CLAMP PULSE
(25) BLANKING PULSE
(26) TABLE SWITCHING
(27) RRD CONTROL
(28) ANALOG PROCESSING UNIT
(29) R GAIN ADJUSTMENT
(30) R OFFSET ADJUSTMENT
(31) CLAMP PULSE
(32) BLANKING PULSE
(33) G GAIN ADJUSTMENT
(34) G OFFSET ADJUSTMENT
(35) CLAMP PULSE
(36) ANALOG PROCESSING UNIT
(37) B GAIN ADJUSTMENT
(38) B OFFSET ADJUSTMENT
(39) BLANKING PULSE
(40) INVERTED γ TABLE
(41) TABLE CONTROL
(42) INVERTED γ TABLE
(43) G WRT CONTROL
(44) TABLE CONTROL
(45) G LINE MEMORY
(46) GRD CONTROL
(47) X-DRIVER CONTROL
(48) XY DRIVER TIMING GENERATION
(49) B WRT CONTROL
(50) B LINE MEMORY
(51) BRD CONTROL
(52) H TABLE ROW CONTROL
(53) LATCH CIRCUIT
(54) SHIFT REGISTER CIRCUIT
   FIG. 2
(1) DECODED COMPONENT VIDE SIGNAL
(2) COLOR SAMPLE DATA
(3) BRIGHTNESS DATA
(4) PWNGEN OUTPUT
(5) H-LEVEL
(6) OUUTPUT VOLTAGE WAVEFORM OF A LINE
(7) 1ST LINE OUTPUT
(8) 2ND LINE OUTPUT
(9) 3RD LINE OUTPUT
(10) 240THE LINE OUTPUT
(11) 2ND LINE
(12) 3RD LINE
(13) 4TH LINE
(14) mTH LINE
(15) 1ST LINE
(16) 2ND LINE
(17) 3RD LINE
(18) 240TH LINE
   FIG. 7
SEE FIG. 2
   FIG. 12
SEE FIG. 2
   FIG. 14
SEE FIG. 2
   FIG. 15
(1) TV SIGNAL (RADIO TRANSMISSION SYSSTEM)
(2) TV SIGNAL (CABLE TRANSMISSION SYSSTEM)
(3) IMAGE INPUT UNIT (TV CAMERA)
(4) IMAGE MEMORY (VTR)
(5) IMAGE MEMORY (VIDEO DISK)
(6) IMAGE MEMORY (STILL IMAGE DISK)
(7) COMPUTER NETWORK
(8) PRINTER
(9) TV SIGNAL RECEIVING CIRCUIT
(10) TV SIGNAL RECEIVING CIRCUIT
(11) IMAGE INPUT INTERFACE CIRCUIT
(12) IMAGE INPUT MEMORY INTERFACE CIRCUIT
(13) IMAGE INPUT MEMORY INTERFACE CIRCUIT
(14) IMAGE INPUT MEMORY INTERFACE CIRCUIT
(15) INPUT/OUTPUT INTERFACE CIRCUIT
(16) INPUT UNIT (KEYBOARD, MOUSE, ETC.)
(17) IMAGE GENERATING CIRCUIT
(18) DISPLAY PANEL CONTROLLER
(19) DECODER
(20) IMAGE MEMORY
(21) MULLLTIPLEXER
(22) DRIVING CIRCUIT
(23) DISPLAY PANEL

1-17. (canceled)

18. A signal output method comprising:
a first shifting step of causing a potential of a signal to be shifted from a first potential to a second potential different from the first potential,
wherein the first shifting step includes the sub-steps of:
in a first period, connecting a first portion for supplying a predetermined potential and an output portion for outputting the signal with a predetermined resistance value;
changing from the first period to a second period in which the first portion and the output portion are connected with a resistance value lower than the predetermined resistance value in the first period;
in a third period following the second period, connecting a second portion for supplying a potential different from the predetermined potential and the output portion with a predetermined resistance value; and
changing from the third period to a fourth period in which the second portion and the output portion are connected with a resistance value lower than the predetermined resistance value in the third period.

19. A signal output method according to claim 18, wherein the signal is a pulse signal, and wherein the signal output method includes a forming step of forming either a raising portion or a falling portion of the pulse signal, and the forming step includes at least said first shifting step.

20. A signal output method according to claim 19, further comprising a forming step of forming the other of the raising portion or the falling portion, the forming step of forming the other of the raising portion or the falling portion includes at least a second shifting step of causing the potential of the signal to be shifted from the second potential to the first potential,
wherein the second shifting step includes the sub-steps of:
in a fifth period, connecting the first portion and the output portion with a predetermined resistance value; and
changing from the fifth period to a sixth period in which the first portion and the output portion are connected with a resistance lower than the predetermined resistance value in the fifth period.

21. A signal output method according to claim 19, further comprising a forming step of forming the other of the raising portion or the falling portion, the forming step of forming the other of the raising portion or the falling portion includes at least a second shifting step of causing the potential of the signal to be shifted from the second potential to the first potential,
wherein the second shifting step includes the sub-steps of:
in a further period, connecting a third portion, for supplying a potential different from the potential supplied from each of the first portion and the second portion, and the output portion with a predetermined resistance value; and
changing from the further period to another period in which the third portion and the output portion are connected with a resistance value lower than the predetermined resistance value in the further period.

22. A signal output method according to claim 18, wherein the predetermined potential supplied by the first portion is a potential between the first potential and the second potential.

23. An image display method comprising:
a first shifting step of causing a potential of a signal to be shifted from a first potential to a second potential different from the first potential, the signal being supplied to an image forming device,
wherein the first shifting step includes the sub-steps of:
in a first period, connecting a first portion for supplying a predetermined potential and an output portion for outputting the signal with a predetermined resistance value;
changing from the first period to a second period in which the first portion and the output portion are connected with a resistance value lower than the predetermined resistance value in the first period;
in a third period following the second period, connecting a second portion for supplying a potential different from the predetermined potential and the output portion with a predetermined resistance value; and
changing from the third period to a fourth period in which the second portion and the output portion are connected with a resistance value lower than the predetermined resistance value in the third period.

24. An image display method according to claim 23, wherein the signal is a pulse signal, and wherein the signal output method includes a forming step of forming either a raising portion or a falling portion of the pulse signal, and the forming step includes at least said first shifting step.

25. An image display method according to claim 24, further comprising a forming step of forming the other of the raising portion or the falling portion, the forming step of forming the other of the raising portion or the falling portion includes at least a second shifting step of causing the potential of the signal to be shifted from the second potential to the first potential,
wherein the second shifting step includes the sub-steps of:
in a fifth period, connecting the first portion and the output portion with a predetermined resistance value; and
changing the fifth period to a sixth period in which the first portion and the output portion are connected with a resistance lower than the predetermined resistance value in the fifth period.

26. An image display method according to claim 24, further comprising a forming step of forming the other of the raising portion or the falling portion, the forming step of forming the other of the raising portion or the falling portion includes at least a second shifting step of causing the potential of the signal to be shifted from the second potential to the first potential,
wherein the second shifting step includes the sub-steps of:
in a further period, connecting a third portion, for supplying a potential different from the potential supplied from each of the first portion and the second portion, and the output portion with a predetermined resistance value; and
changing from the further period to another period in which the third portion and the output portion are connected with a resistance value lower than the predetermined resistance value in the further period.

27. An image display method according to claim 23, wherein the predetermined potential supplied by the first portion is a potential between the first potential and the second potential.

28. An image display method according to claim 23, wherein the signal is a signal applied to a modulation wiring to which an image forming element is connected.

29. A signal output method comprising:
a first shifting step of causing a potential of a signal to be shifted from a first potential to a second potential different from the first potential,
wherein the first shifting step includes the sub-steps of:
in a first period, controlling a resistance value between a first potential supply portion for supplying a predetermined potential and an output portion for outputting the signal so that the resistance value is a predetermined value;
in a second period to which the first period is changed, controlling the resistance value between the first potential supply portion and the output portion so that the resistance value is lower than the predetermined value in the first period;
in a third period following the second period, controlling a resistance value between a second potential supply portion for supplying a potential, that is different from the predetermined potential and the output portion so that the resistance value is a predetermined value; and
in a fourth period to which the third period is changed, controlling the resistance value between the second potential supply portion and the output portion so that the resistance value is lower than the predetermined value in the third period.

30. A signal output method according to claim 29, wherein the signal is a pulse signal, and wherein the signal output method includes a forming step of forming either a raising portion or a falling portion of the pulse signal, and the forming step includes at least said first shifting step.

31. A signal output method according to claim 30, further comprising a forming step of forming the other of the raising portion or the falling portion, the forming step of forming the other of the raising portion or the falling portion includes at least a second shifting step of causing the potential of the signal to be shifted from the second potential to the first potential,
wherein the second shifting step includes the sub-steps of:
in a fifth period, controlling the resistance value between the first potential supply portion for supplying a predetermined potential and the output portion so that the resistance value is a predetermined value; and
in a sixth period to which the fifth period is changed, controlling the resistance value between the first potential supply portion and the output portion so that the resistance value is lower than the predetermined value in the fifth period.

32. A signal output method according to claim 30, further comprising a forming step of forming the other of the raising portion or the falling portion, the forming step of forming the other of the raising portion or the falling portion includes at least a second shifting step of causing the potential of the signal to be shifted from the second potential to the first potential,
wherein the second shifting step includes the sub-steps of:
in a further period, controlling a resistance value between a third potential supply portion for supplying a predetermined potential different from potentials supplied from each of the first and second potential supply portions and the output portion so that the resistance value is a predetermined value; and
in another period to which the further period is changed, controlling the resistance value between the third potential supply portion and the output portion so that the resistance value is lower than the resistance value in the further period.

33. A signal output method according to claim 29, wherein the predetermined potential supplied by the first potential supply portion is a potential between the first potential and the second potential.

34. An image display method comprising:
a first shifting step of causing a potential of a signal to be shifted from a first potential to a second potential different from the first potential, the signal being supplied to an image forming device,
wherein the first shifting step includes the sub-steps of:
in a first period, to controlling a resistance value between a first potential supply portion for supplying a predetermined potential and an output portion for outputting the signal so that the resistance value is a predetermined value;
in a second period to which the first period is changed, controlling the resistance value between the first potential supply portion and the output portion so that the resistance value is lower than the predetermined value in the first period;
in a third period following the second period, controlling a resistance value between a second potential supply portion for supplying a potential, that is different from the predetermined potential and the output portion so that the resistance value is a predetermined value; and
in a fourth period to which the third period is changed, controlling the resistance value between the second potential supply portion and the output portion so that the resistance value is lower than the predetermined value in the third period.

35. An image display method according to claim 34, wherein the signal is a pulse signal, and wherein the signal output method includes a forming step of forming either a raising portion or a falling portion of the pulse signal, and the forming step includes at least said first shifting step.

36. An image display method according to claim 35, further comprising a forming step of forming the other of the raising portion or the falling portion, the forming step of forming the other of the raising portion or the falling portion includes at least a second shifting step of causing the potential of the signal to be shifted from the second potential to the first potential,
wherein the second shifting step includes the sub-steps of:
in a fifth period, controlling the resistance value between the first potential supply portion for supplying a predetermined potential and the output portion so that the resistance value is a predetermined value; and
in a sixth period to which the fifth period is changed, controlling the resistance value between the first potential supply portion and the output portion so that the resistance value is lower than the predetermined value in the fifth period.

37. An image display method according to claim 35, further comprising a forming step of forming the other of the raising portion or the falling portion, the forming step of forming the other of the raising portion or the falling portion includes at least a second shifting step of causing the potential of the signal to be shifted from the second potential to the first potential,
wherein the second shifting step includes the sub-steps of:
in a further period, controlling a resistance value between a third potential supply portion supplying a predetermined potential different from potentials supplied from each of the first and second potential supply portions and the output portion so that the resistance value is a predetermined value; and
in another period to which the further period is changed, controlling the resistance value between the third potential supply portion and the output portion so that the resistance value is lower than the resistance value in the further period.

38. An image display method according to claim 34, wherein the predetermined potential supplied by the first potential supply portion is a potential between the first potential and the second potential.

39. An image display method according to claim 34, wherein the signal is a signal applied to a modulation wiring to which an image forming element is connected.

40. A method for modulating a signal, the method comprising:
a first shifting step of causing a potential of the signal to be shifted from a first potential to a second potential different from the first potential,
wherein the first shifting step includes the sub-steps of:
supplying a potential from a first potential source to an output terminal through a first circuit section, the first circuit section having a plurality of first switch devices that are connected in parallel with each other and arranged in an electrical path between the first potential source and the output terminal,
during the supplying, turning on the plurality of first switch devices in succession, so that any first switch device having a lesser ON resistance value is turned on later than any first switch device having a greater ON resistance value among the first switch devices,
supplying a potential from a second potential source to the output terminal through a second circuit section, the second circuit section having a plurality of second switch devices that are connected in parallel with each other and arranged in an electrical path between the second potential source and the output terminal, and
during the supplying of the potential from the second potential source, turning on the plurality of second switch devices in succession, so that any second switch device having a lesser ON resistance value is turned on later than any second switch device having a greater ON resistance value among the second switch devices.

41. A method according to claim 40, wherein the signal is a pulse signal, and the first shifting step causes the potential of the signal to either rise from the first potential to the second potential, or fall from the first potential to the second potential.

42. A method according to claim 40, further comprising a second shifting step of causing the potential of the signal to be shifted from the second potential to the first potential,
wherein said second shifting step includes the sub-steps of:
further supplying a potential from the first potential source to the output terminal through the first circuit section; and
during the further supplying, turning on at least some of the plurality of first switch devices in succession, so that any first switch device having a lesser ON resistance value is turned on later than any first switch device having a greater ON resistance value among the at least some first switches.

43. A method according to claim 42, wherein the signal is a pulse signal, and the first shifting step causes the potential of the signal to either rise from the first potential to the second potential, or fall from the first potential to the second potential, and the second shifting step causes the potential of the signal to either fall from the second potential to the first potential, or rise from the second potential to the first potential, respectively.

44. A method according to claim 40, further comprising a second shifting step of causing the potential of the signal to be shifted from the second potential to the first potential, wherein said second shifting step includes the sub-steps of:
supplying a potential, different from potentials supplied from the first and second potential sources, from a third potential source to the output terminal through a third circuit section, the third circuit section having a plurality of third switch devices that are connected in parallel with each other and arranged in an electrical path between the third potential source to the output terminal; and
during the supplying of the potential from the third potential source, turning on the plurality of third switch devices in succession, so that any third switch device having a lesser ON resistance value is turned on later than any third switch device having a greater ON resistance value among the third switch devices.

45. A method according to claim 44, wherein the signal is a pulse signal, and the first shifting step causes the potential of the signal to either rise from the first potential to the second potential, or fall from the first potential to the second potential, and the second shifting step causes the potential of the signal to either fall from the second potential to the first potential, or rise from the second potential to the first potential, respectively.

46. A method according to claim 40, wherein the potential supplied by the first potential source has a value that is between values of the first potential and the second potential.

47. A method according to claim 40, wherein the output terminal is connected to at least one image forming element, and wherein the method further comprises forwarding the signal shifted in the first shifting step to the at least one image forming element through the output terminal.

48. A method according to claim 40, further comprising, before the supplying of the potential from the second potential source, turning off the first switch devices.

49. A method according to claim 40, further comprising turning off the second switch devices.
